(19) United States
(12) Patent Application Publication
(10) Pub. No.: US 2026/0081643 A1
(43) Pub. Date: Mar. 19, 2026

(54) METHOD AND APPARATUS FOR TRACKING DIRECT SEQUENCE SPREAD SPECTRUM SIGNAL IN FRACTIONAL FOURIER DOMAIN

(71) Applicant: AUROXAT Inc., Lewis, DE (US)

(72) Inventors: Yiran Luo, Calgary (CA); Yi-Fen Tseng, Hsinchu County (TW); Naser EI-Sheimy, Calgary (CA)

(21) Appl. No.: 19/326,780

(22) Filed: Sep. 12, 2025

Related U.S. Application Data
(60) Provisional application No. 63/694,209, filed on Sep. 13, 2024.

(51) Int. Cl. H04B 1/7085; H04B 1/10; H04B 1/69

(52) U.S. Cl. CPC H04B 1/7085; H04B 1/1081; H04B 2001/6912

(57) ABSTRACT

The present disclosure provides a method and an apparatus for tracking a direct sequence spread spectrum (DSSS) signal in a fractional Fourier domain (FRFD). The method includes the steps of: receiving an intermediate frequency (IF) DSSS signal; removing a Doppler frequency component by mixing with local sine and cosine waveforms generated by a carrier numerically controlled oscillator (NCO) to obtain in-phase (I) and quadra-phase (Q) carrier-stripped samples; performing code tracking and integration/dumping operations in the FRFD using chirp-signal modulation; discriminating carrier phase errors via I and Q prompt correlations and code chip errors via I and Q early/late correlations through carrier and code discriminators; filtering the discriminated errors through low-pass loop filters; and using filter outputs to generate carrier and code measurements while adjusting carrier and code NCOs for real-time tracking in subsequent epochs.

### FIELD OF THE INVENTION

The present disclosure generally relates to the field of signal processing in navigation systems and, more specifically, to a method and apparatus for tracking direct sequence spread spectrum (DSSS) signals in a fractional Fourier domain (FRFD).

### BACKGROUND OF THE INVENTION

In today's digital age, the performance of Global Navigation Satellite System (GNSS) receivers has significantly improved, advancing from hundreds of meters to sub-meter accuracy or better. This progress is primarily due to expanded satellite numbers, enhanced navigation constellations, and improved signal designs. However, the core of a GNSS receiver—the baseband processor—still largely relies on conventional methods like the Fast Fourier Transform (FFT) and convolution/correlation calculations, which has created performance bottlenecks that limit robust mitigation of multipath and interference, especially in dense urban canyons and high-dynamic scenarios where signals are severely distorted and conventional tracking may lose lock or yield biased code-phase estimates.

A key determinant of receiver performance is the autocorrelation function (ACF) of the spreading code. Codes with a narrower ACF main lobe better suppress short non-line-of-sight (NLOS) multipath; for example, high-rate signals such as GPS L5 generally outperform lower-rate signals like GPS L1 C/A in multipath environments. Existing countermeasures—e.g., adjusting early-minus-late (E-L) spacing, adding more correlators, or using multipath-estimating DLLs (MEDLL)—modify discriminator behavior but do not change the fundamental ACF envelope, leaving performance bounded by the original code design. Conventional receivers also perform code tracking in a one-dimensional time domain using early/prompt/late (E/P/L) channels, which further constrains bias mitigation.

Extending coherent integration to improve sensitivity exposes another limitation: time-varying Doppler from relative acceleration introduces a Doppler-rate term that winds carrier phase across the coherent interval. If unmodeled, correlation gain degrades and loss-of-lock can occur. Prior approaches that attempted fractional Fourier transform (FRFT/DFRFT) processing for DSSS estimation suffered high computational burden, offered no ACF-shape improvement, and often required time-consuming coarse-to-fine searches. Other proposals exploited chirp modulation but demanded modifications to both transmitter and receiver—impractical for existing GNSS satellites.

Accordingly, there is a need for a baseband tracking architecture that (i) elevates processing beyond the one-dimensional time domain to jointly handle frequency evolution (including Doppler-rate effects), (ii) effectively narrows the observed ACF main lobe without changing the transmitter, (iii) preserves computational tractability via closed-form design of search steps, and (iv) generalizes beyond GNSS to other navigation signals, including low-Earth-orbit (LEO) satellite and LTE/5G signals, thereby enabling robust operation in multipath-and interference-rich environments.

### SUMMARY OF THE INVENTION

To address the above technical issues, the present disclosure provides a method and an apparatus that can elevate the core baseband processor of a GNSS receiver from one-dimensional (1D) processing to a two-dimensional (2D) approach using fractional Fourier transform (FRFT) theory. This improves the tracking accuracy and ability of the receiver to mitigate multipath and interference in challenging environments at a low cost, without requiring any modifications to the GNSS satellites or their transmitted signals.

One aspect of the present disclosure provides a method for tracking a direct sequence spread spectrum (DSSS) signal in a fractional Fourier domain (FRFD), the method including the steps of: receiving an intermediate frequency (IF) DSSS signal; removing a Doppler frequency component from the received IF DSSS signal by mixing with local sine and cosine waveforms generated by a carrier numerically controlled oscillator (NCO) to obtain a plurality of in-phase (I) and quadra-phase (Q) carrier-stripped signal samples; performing code tracking and integration-and-dumping (I-and-D) implementations in the FRFD; discriminating carrier phase errors using I and Q prompt correlations and discriminating code chip errors using I and Q early and late correlations via carrier and code discriminators; processing the discriminated carrier phase errors and the discriminated code chip errors through a low-pass carrier and code loop filter; and using outputs of the low-pass carrier and code loop filter to generate carrier and code measurements and to adjust the carrier NCO and a code NCO in real time for tracking the received IF signals in a next epoch.

Another aspect of the present disclosure provides an apparatus for tracking a direct sequence spread spectrum (DSSS) signal in a fractional Fourier domain (FRFD), the apparatus including: a mixer configured to remove a Doppler frequency component from a received intermediate frequency (IF) DSSS signal by mixing with local sine and cosine waveforms to obtain a plurality of in-phase (I) and quadra-phase (Q) carrier-stripped signal samples; a carrier numerically controlled oscillator (NCO) configured to generate the local sine and cosine waveforms; a code NCO configured to generate local spreading code replica samples; a processing module configured to perform code tracking and integration-and-dumping (I-and-D) implementations in the FRFD; a chirp-signal NCO configured to generate sine and cosine local chirp signal replicas; and a receiver processor configured to: discriminate carrier phase errors using I and Q prompt correlations; discriminate code chip errors using I and Q early and late correlations; process the discriminated errors through low-pass loop filters, and generate carrier and code measurements for adjusting the carrier NCO and the code NCO.

### BRIEF DESCRIPTION OF DRAWINGS

The above-mentioned technical features, advantages and implementations of the present disclosure will become apparent from the following description of preferred embodiments with reference to the accompanying drawings.

FIG. 1 is a flowchart of a method for tracking a direct sequence spread spectrum (DSSS) signal in a fractional Fourier domain (FRFD) according to one embodiment of the present disclosure;

FIG. 2 is a flowchart of performing code tracking and integration-and-dumping implementations in the FRFD according to one embodiment of the present disclosure;

FIG. 3 is a schematic diagram of an apparatus for tracking a direct sequence spread spectrum (DSSS) signal in a fractional Fourier domain (FRFD) according to one embodiment of the present disclosure;

FIG. 4 is a schematic diagram of a processing module according to one embodiment of the present disclosure;

FIG. 5 is a schematic diagram of a chirp code wipeoff and I-and-D unit according to one embodiment of the present disclosure;

FIG. 6 is a schematic diagram of a receiver processor according to one embodiment of the present disclosure;

FIG. 7 is a schematic diagram of a carrier loop discriminator according to one embodiment of the present disclosure;

FIG. 8 is a schematic diagram of a code loop discriminator according to one embodiment of the present disclosure; and

FIG. 9 shows a comparison of correlation amplitude results from the embodiment of FIG. 5 with conventional correlation amplitude results.

### DETAILED DESCRIPTION OF THE INVENTION

In order to explain the embodiments of the present disclosure or the technical solutions in the prior art more clearly, the specific implementations of the present disclosure will be described in detail with reference to the accompanying drawings. Apparently, the drawings described below are merely some embodiments of the present disclosure. According to these drawings, those of ordinary skill in the art can obtain other drawings and adopt other implementation without creative efforts.

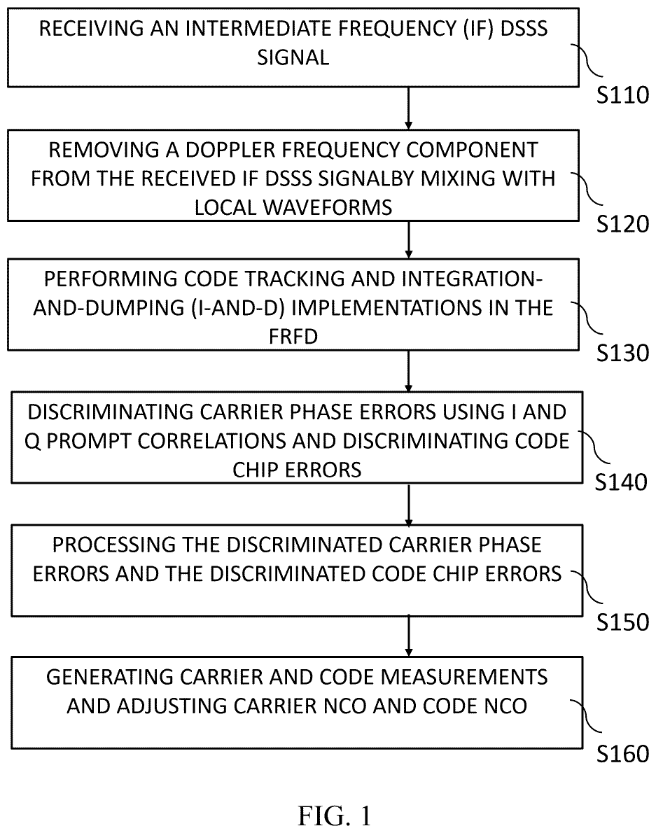

Please refer to FIG. 1, which is a flowchart of a method for tracking a direct sequence spread spectrum (DSSS) signal in a fractional Fourier domain (FRFD) according to one embodiment of the present disclosure. In FIG. 1, the method begins with Step S110, which is performed to receive an intermediate frequency (IF) DSSS signal. In S110, a receiver accepts the intermediate-frequency (IF) DSSS signal. An antenna and RF front-end perform low-noise amplification with automatic gain control (AGC), preselection/channel-select filtering, and down-conversion to the chosen IF (including low-IF or zero-IF variants), followed by anti-alias filtering and digitization by an analog-to-digital converter (ADC). The result of S110 is a stream of quantized IF samples.

The Step S110 output preserves the spreading-code bandwidth and expected Doppler excursion and may include front-end status (e.g., AGC gain, saturation flags) for later loop configuration. This IF sample stream is then provided to Step S120 which is performed to remove a Doppler frequency component from the received IF DSSS signal by mixing with local sine and cosine waveforms generated by a carrier numerically controlled oscillator (NCO) to obtain a plurality of in-phase (I) and quadra-phase (Q) carrier-stripped signal samples. In Step S120, a digital phase accumulator drives a sine/cosine lookup (or CORDIC) to produce the local replicas; its frequency-control word is set from an initial Doppler estimate (from ephemeris, aiding, or a coarse acquisition sweep). The IF samples are multiplied by the cosine and sine replicas to realize a complex down-conversion; optional low-pass filtering and decimation follow to reject images and align the processing rate to the correlator. Calibration of DC offset and I/Q imbalance (gain/phase corrections) may be applied, and AGC metadata can be used to normalize amplitude so that subsequent correlator metrics remain unbiased. The residual frequency and Doppler-rate are intentionally left within a bounded range to be handled by the FRFD stage.

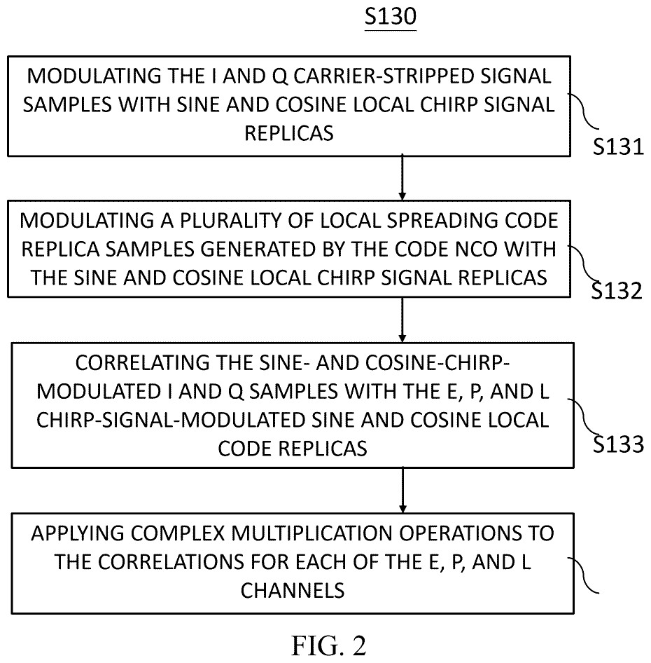

The carrier-stripped I/Q stream output by Step S120 initializes the FRFD tracking pipeline: these complex samples feed Step S130 for performing code tracking and integration-and-dumping in the FRFD, as shown in FIG. 2. In FIG. 2, Step S131 is first performed to modulate the I and Q carrier-stripped signal samples with sine and cosine local chirp signal replicas generated by a chirp-signal NCO. In one embodiment, a digital phase accumulator and sine/cosine generator produce cosine-and sine-chirp sequences whose chirp rate (or FRFT-order) is selected from a closed-form design to bound correlation loss. The received I and Q branches are each mixed with the corresponding chirp replica over the coherent integration interval, thereby projecting the signal into a fractional Fourier domain (FRFD) that compensates residual Doppler-rate while preserving coherent gain.

Then, in Step S132, a plurality of local spreading code replica samples generated by the code NCO are modulated with the sine and cosine local chirp signal replicas, wherein early (E), prompt (P), and late (L) channels are adjusted by local chirp signal phases. The E/P/L spacing is realized by chirp-phase offsets rather than only by time delays, enabling fine control of the effective discriminator slope in the FRFD. The chirp-modulated code replicas thus constitute the local references against which the received, chirp-modulated I/Q streams are compared.

In Step S133, the sine-and cosine-chirp-modulated I and Q samples are correlated with the E, P, and L chirp-signal-modulated sine and cosine local code replicas via an I and Q processor. For each channel, complex products are accumulated over the coherent interval to yield complex correlation outputs that are robust to time-varying Doppler. These per-channel correlations feed the subsequent carrier and code discriminators.

In Step S134, complex multiplication operations are applied to the correlations for each of the E, P, and L channels. The resulting E, P, L complex correlation samples are then forwarded to the loop discriminators and to the measurement engine for downstream processing.

In one embodiment, a single local chirp waveform, either the sine or the cosine component, is applied simultaneously to both the carrier-stripped I/Q stream and the local code replicas. By driving the received and local branches with the same phase-continuous waveform, the design reduces mixers and lookup resources while preserving FRFD selectivity. This maintains coherent phase alignment across branches, simplifies clock-domain crossing, and can be selected dynamically when compute or power budgets are constrained.

In another embodiment, Step S130 supports modulating the local chirp signal replicas to local carrier replicas and to the received path after code wipeoff, thereby allowing the code-wipeoff function to be placed before or after carrier wipeoff. Performing code wipeoff first reduces data-bit interference prior to carrier refinement; performing carrier wipeoff first reduces correlation sidelobes before code removal. The pipeline thus exposes two legal orderings to optimize for quantization noise, residual Doppler, and memory bandwidth under different front-end plans.

In one embodiment, when platform dynamics and Doppler-rate are sufficiently small, Step S130 may replace the local chirp replicas with unchanged-frequency sine and cosine waveforms. These constant-frequency replicas are applied simultaneously to the received IF DSSS signal and to the local code replicas, effectively reverting to a 1-D correlation regime while keeping the outer loop and discriminator structures intact. This fallback minimizes computational load and is useful during benign kinematics or steady hover conditions.

In one embodiment, the chirp rate (equivalently, FRFT order) used in Step S130 is computed from a closed-form analytical model that guarantees a predefined correlation-power threshold across the Doppler-rate dimension. Given a target loss bound and coherent interval T, the model yields an optimal rate and a coarse grid with minimal hypotheses, thereby minimizing search complexity during acquisition/hold-in while maintaining discriminator slope and measurement fidelity. This design rule governs both initial selection and adaptive updates under changing dynamics.

Returning to FIG. 1, Step S140 is then performed to discriminate carrier phase errors using I and Q prompt correlations and discriminate code chip errors using I and Q early and late correlations via carrier and code discriminators. In Step S140, the carrier loop discriminator operates on prompt I/Q and may first combine multiple prompt branches via adders before the PLL estimator, while the code loop discriminator forms a normalized early-minus-late timing error from the early/late I/Q correlations, optionally combining multiple E/L taps to sharpen discriminator slope. The discriminated carrier-phase/frequency and code-phase innovations are then low-pass filtered and used both to update the carrier and code NCOs and to generate carrier-phase and pseudorange measurements for the navigator. The number of input correlations and the adder networks are configurable per channel design and may exceed the basic E/P/L set described above.

Then, Step S150 is then performed to process the discriminated carrier phase errors and the discriminated code chip errors through a low-pass carrier and code loop filter. In Step S150, a carrier loop filter smooths the prompt-derived carrier innovation to yield filtered carrier phase/frequency, and a code loop filter (e.g., a DLL or Kalman) smooths the early/late timing innovation to yield filtered code phase/rate.

At last, Step S160 is then performed to use outputs of the low-pass carrier and code loop filter to generate carrier and code measurements and to adjust the carrier NCO and a code NCO in real time for tracking the received IF signals in a next epoch. In Step 160, the filtered carrier and code states from Step S150 are time-tagged and converted into measurements with associated quality and lock indicators. Updated control words are then applied to the carrier NCO and the code NCO to align mixing and code replication for the next epoch, and the measurements are exported to the navigator for positioning, navigation and timing (PNT) and optional acquisition/vector-tracking aiding.

In one embodiment, the method further includes conducting a plurality of pseudorange and carrier phase measurements based on the outputs of the loop filter; and inputting the measurements to a navigator to compute positioning, navigation, or timing solutions.

In one embodiment, the method further includes conducting a plurality of pseudorange and carrier phase measurements based on the outputs of the loop filter; and inputting the measurements to a navigator to compute positioning, navigation, or timing solutions. The navigator may further refine these solutions by integrating additional satellite signals or external aiding information, thereby enhancing accuracy and continuity under weak signal or obstructed environments.

In one embodiment, the method further includes using the outputs of the carrier and code loop filter to compensate for code phase errors and Doppler frequency errors in an acquisition process, wherein the received I and Q carrier-stripped signal samples and local signal replicas are selectively modulated by sine and cosine local chirp signal replicas during acquisition processing. This compensation facilitates faster and more reliable acquisition of satellite signals, especially in high-dynamics or interference-prone conditions.

In one embodiment, the method further includes disabling the low-pass carrier and code loop filter, so that outputs of a code and carrier discriminator are used for producing pseudorange and carrier phase measurements in open-loop and snapshot receiver architectures, and the outputs of the code and carrier discriminator are used for compensating Doppler frequency errors and the code chip errors of the code NCO and the carrier NCO. This configuration allows flexible adaptation of the receiver for low-power or intermittent tracking applications without sacrificing measurement fidelity.

In one embodiment, the method further includes forming additional correlators and implementing a code phase discriminator based on multi-channel correlations using a multipath estimation delay lock loop (MDELL) algorithm and variations thereof by designing early and late channels in a receiver architecture. Such design enables effective mitigation of multipath effects, thereby improving the robustness and precision of code phase tracking in urban or reflective environments.

In one embodiment, the received IF DSSS signal and local signal replicas modulated by local chirp signal replicas are adopted in receivers using vector delay lock loop (VDLL) and vector phase lock loop (VPLL) architectures. These vector-based tracking architectures allow joint estimation across multiple signals, leading to improved navigation performance under challenging propagation conditions.

In one embodiment, the received IF DSSS signal and local signal replicas modulated by local chirp signal replicas are adopted in a deeply coupled GNSS/inertial navigation system (INS). The deep integration enables tighter feedback between GNSS measurements and inertial sensor outputs, which enhances positioning resilience in GPS-denied or jamming environments.

In one embodiment, the received IF DSSS signal is a global navigation satellite system (GNSS) signal and the method further includes producing a plurality of pseudorange and carrier phase measurements based on estimated code phases, carrier phases and Doppler frequencies; and computing position solutions with the produced pseudorange and carrier phase measurements in a navigator. The navigator may further employ error correction and quality control techniques to ensure integrity and reliability of the computed solutions.

In one embodiment, the step of computing the position solutions is executed by at least one of: a standalone GNSS receiver, an integrated GNSS/inertial sensor navigation system, and a non-GNSS signals-of-opportunity (SoOP) navigation receiver. Each of these implementations provides flexibility in adapting the method to different platforms and operational requirements.

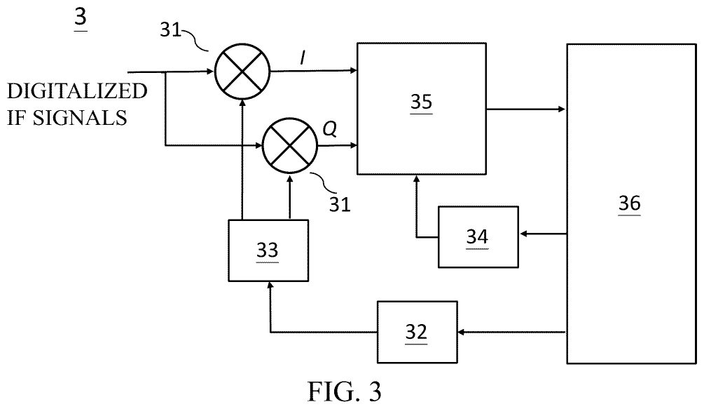

FIG. 3 is a schematic diagram of an apparatus for tracking a direct sequence spread spectrum (DSSS) signal in a fractional Fourier domain (FRFD) according to one embodiment of the present disclosure. The present embodiment elevates the code signal tracking from a one-dimensional (1D) time domain to a two-dimensional (2D) fractional Fourier domain (FRFD). This performance is achieved by simultaneously modulating local sine and cosine chirp signal replicas to the received IF code samples and local code replicas. The spreading code signals' ACF during the baseband processing can access the power peak with a narrower ACF bandwidth. This property enables the DSSS signals to be more effective in suppressing thermal noise power and mitigating interferences, such as multipath effects.

Based on the present embodiment, the GNSS receiver can output more accurate position, navigation and timing (PNT) solutions in any conditions than the ones computed by the traditional receiver. The present embodiment thoroughly upgrades the traditional receiver. It enables the IF DSSS signals to be processed in the baseband processor by leveraging the more generalized FRFT theory instead of the ordinary Fourier transform (FT) theory.

In FIG. 3, the apparatus 3 includes a mixer 31, a carrier numerically controlled oscillator (NCO) 32, a code NCO 34, a processing module 35, and a receiver processor 36. The mixer 31 is configured to remove a Doppler frequency component from a received intermediate frequency (IF) DSSS signal by mixing with local sine and cosine waveforms to obtain a plurality of in-phase (I) and quadra-phase (Q) carrier-stripped signal samples. In one embodiment, the mixer 31 can be implemented by parallel multipliers to simultaneously generate I and Q components, thereby enabling robust carrier wipe-off performance under high Doppler dynamics.

The input digitalized IF signals of the apparatus 3 are produced by a radio frequency (RF) frontend, which receives the RF signals from an antenna. In the RF frontend, the RF signals are amplified by a low-noise amplifier. The amplified RF signals are then down-converted to the IF. The digitalized IF signals are finally obtained after the analog-to-digital converter (ADC) and automatic gain control (AGC) processing at the IF. Sometimes, the downconversion process can be implemented in a high-speed digital processor.

The carrier NCO 32 is configured to generate the local sine and cosine waveforms through a cos/sin map block 33. In one embodiment, the cos/sin map block 33 may be realized by a look-up table (LUT) or a CORDIC algorithm to efficiently produce high-precision sinusoidal waveforms, ensuring stable phase continuity and low quantization error in real-time GNSS signal tracking.

The code NCO 34 is configured to generate local spreading code replica samples. In one embodiment, the code NCO 34 can be adaptively adjusted according to the outputs of the code loop filter, and its design may include programmable logic to support multiple code rates across different GNSS constellations, thereby increasing system scalability.

The processing module 35 is configured to perform code tracking and integration-and-dumping (I-and-D) implementations in the FRFD. In one embodiment, the processing module 35 further incorporates chirp-signal-modulated correlators that enhance multipath suppression and allow for longer coherent integration times without loss of sensitivity.

The receiver processor 36 is configured to: discriminate carrier phase errors using I and Q prompt correlations; discriminate code chip errors using I and Q early and late correlations; process the discriminated errors through low-pass loop filters (not shown); and generate carrier and code measurements for adjusting the carrier NCO 32 and the code NCO 34. In one embodiment, the low-pass loop filters comprise at least one filter selected from the group consisting of delay lock loop (DLL), phase lock loop (PLL), frequency lock loop (FLL), Kalman filter (KF), maximum likelihood estimator (MLE), and maximum a posteriori estimator (MAP). The selection or combination of these filters may be dynamically adapted according to signal conditions, where advanced estimators like KF, MLE, and MAP provide robustness in multipath-rich or weak-signal environments. In one embodiment, the receiver processor 36 may also interface with external aiding sensors or vector-tracking algorithms, thereby improving robustness in weak-signal or highly dynamic environments.

In one embodiment, the apparatus 3 further includes a chirp-signal NCO (not shown) configured to modulate the I and Q carrier-stripped signal samples with sine and cosine local chirp signal replicas. In one embodiment, the chirp-signal NCO is configured to generate chirp rates determined from a closed-form analytical model that guarantees a predefined correlation power threshold in the Doppler rate dimension, thereby reducing search complexity.

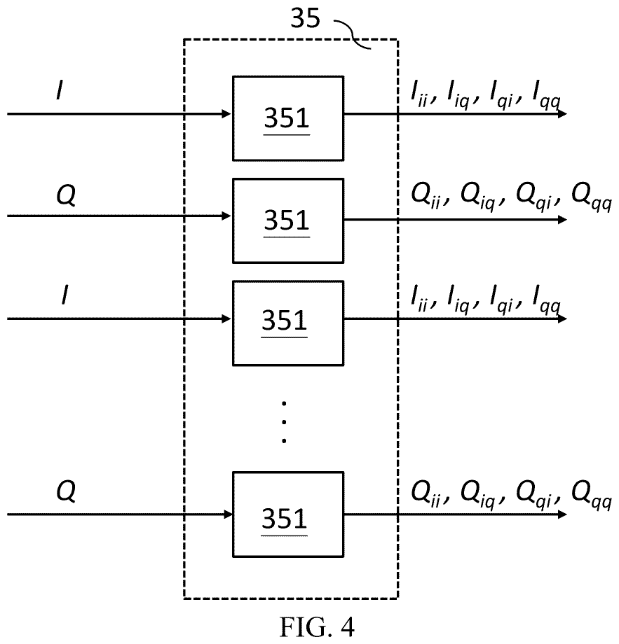

Please refer to FIG. 4, which is a schematic diagram of a processing module according to one embodiment of the present disclosure. In FIG. 4, the processing module 35 includes a plurality of chirp code wipeoff and I-and-D units 351. Each of the chirp code wipeoff and I-and-D units 351 is configured to output correlation samples Iᵢᵢ, I_{iq}, I_{qi}, I_{qq}, Qᵢᵢ, Q_{iq}, Q_{qi}, Q_{qq}, based on sine-and cosine-chirp-signal-modulated received I and Q samples and sine- and cosine-chirp-signal-modulated local code samples.

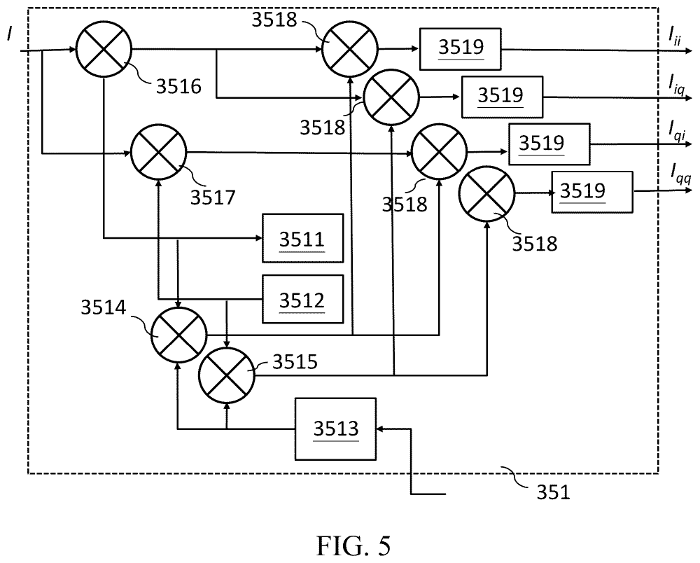

Please refer to FIG. 5, which is a schematic diagram of a chirp code wipeoff and I-and-D unit according to one embodiment of the present disclosure. In FIG. 5, the chirp code wipeoff and I-and-D unit 351 includes a cosine chirp carrier generator 3511, a sine chirp carrier generator 3512, a spreading code generator 3513, a local code and cosine chirp carrier modulator 3514, a local code and sine chirp carrier modulator 3515, a received code and cosine chirp carrier modulator 3516, a received code and sine chirp carrier modulator 3517, a plurality of code wipeoff function operators 3518, and a plurality of I-and-D function operators 3519.

In one embodiment, the cosine chirp carrier generator 3511 is configured to generate cosine chirp signal waveforms. The sine chirp carrier generator 3512 is configured to generate sine chirp signal waveforms. The spreading code generator 3513 is configured to generate local pseudorandom noise (PRN) code replicas. The local code and cosine chirp carrier modulator 3514 is configured to modulate local code replicas with cosine chirp signals. The local code and sine chirp carrier modulator 3515 is configured to modulate local code replicas with sine chirp signals. The received code and cosine chirp carrier modulator 3516 is configured to modulate received carrier-stripped samples with cosine chirp signals. The received code and sine chirp carrier modulator 3517 is configured to modulate received carrier-stripped samples with sine chirp signals. Each of the plurality of code wipeoff function operators 3518 is configured to multiply outputs of the modulators. Each of the plurality of I-and-D function operators 3519 is configured to process outputs of the code wipeoff functions. The outputs of the code wipeoff functions pass through the four I-and-D function implementations, yielding four correlation samples Iᵢᵢ, I_{iq}, I_{qi}, I_{qq}. The carrier-stripped Q IF samples are also processed by the chirp code wipeoff and I-and-D module 351 which produces Qᵢᵢ, Q_{iq}, Q_{qi}, Q_{qq}. According to the present embodiment, the number of code wipeoff and I-and-D functions may vary based on different baseband processing algorithms.

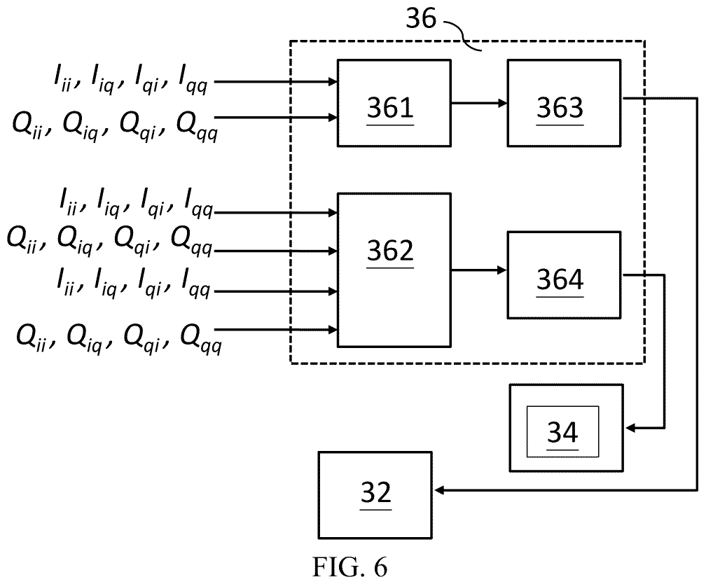

Please refer to FIG. 6, which is a schematic diagram of a receiver processor according to one embodiment of the present disclosure. In FIG. 6, the receiver processor 35 includes a carrier loop discriminator 361, a code loop discriminator 362, a carrier loop filter 363, and a code loop filter 364. In one embodiment, the carrier loop discriminator 361 is configured to receive I and Q correlations from prompt channels and discriminate carrier phase errors. The code loop discriminator 362 is configured to receive I and Q correlations from early and late channels and discriminate code chip errors. The carrier loop filter 363 is configured to process discriminated carrier phase errors. The code loop filter 364 is configured to process discriminated code chip errors.

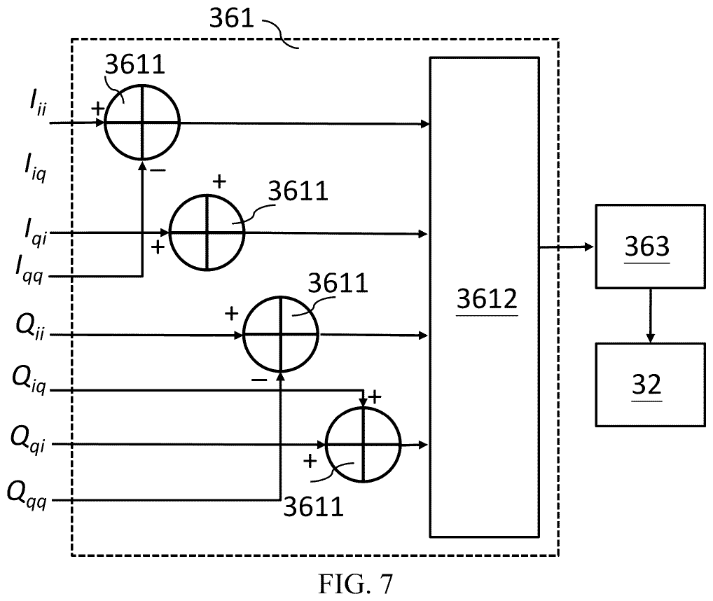

Please refer to FIG. 7, which is a schematic diagram of a carrier loop discriminator according to one embodiment of the present disclosure. In FIG. 7, the carrier loop discriminator 361 includes a plurality of adders 3611, a phase lock loop (PLL) discriminator 3612, such as four-quadrant arctangent function and two-quadrant arctangent function, etc. In one embodiment, each of the plurality of adders 3611 is configured to combine correlation samples. The phase lock loop (PLL) discriminator 3612 is configured to estimate carrier phase errors from combined correlation samples.

The I outputs Iᵢᵢ, I_{iq}, I_{qi}, I_{qq} and Q outputs Qᵢᵢ, Q_{iq}, Q_{qi}, Q_{qq} processed by the chirp code wipeoff and I&D module 351 in the prompt channel are calculated via the adders before input to the PLL discriminator 3612. For example, the two combined real correlations are obtained by subtracting I_{qq} from Iᵢᵢ and adding I_{iq} to I_{qi}, and another two combined real correlations are calculated by subtracting Q_{qq} from Qᵢᵢ and adding Q_{iq} to Q_{qi}; there are toally four combined real correlations computed from the original input Iᵢᵢ, I_{iq}, I_{qi}, I_{qq} and Qᵢᵢ, Q_{iq}, Q_{qi}, Q_{qq} to the carrier loop discriminator 361; these four combined real correlations are input to the PLL discriminator 3612 to estimate the carrier phase error.

The output of the PLL discriminator 3612 is input to the carrier loop filter 363, which is used to update the carrier NCO 32. The PLL discriminator 3612 can also be a FLL discriminator. According to the present embodiment, the number of adders and the number of combined real correlations in the carrier loop discriminator 361 may also vary.

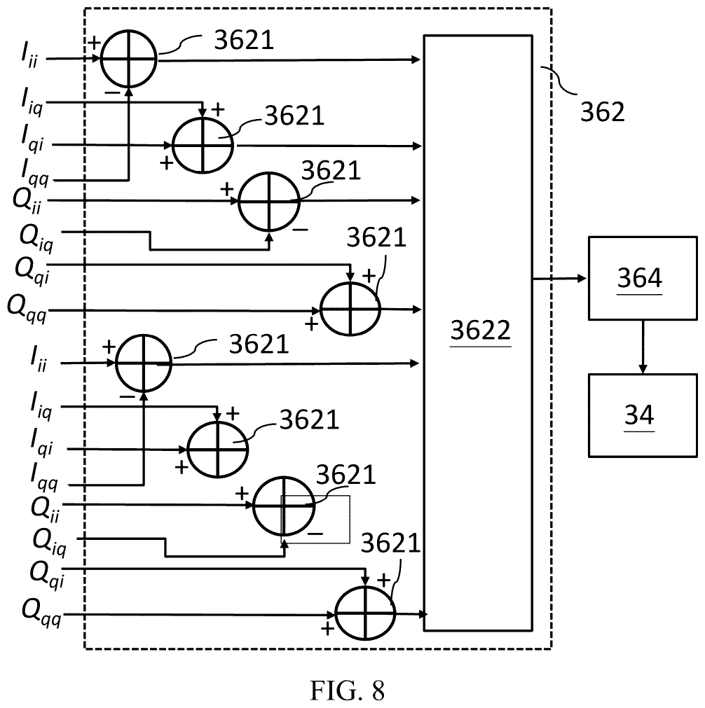

Please refer to FIG. 8, which is a schematic diagram of a code loop discriminator 362 according to one embodiment of the present disclosure. In FIG. 8, the carrier loop discriminator 362 includes a plurality of adders 3621, a code chip error discriminator 3622. In one embodiment, each of the plurality of adders 3621 is configured to combine correlation samples from early and late channels. The code chip error discriminator 3622 is configured to estimate code chip errors from combined correlation samples.

The I outputs Iᵢᵢ, I_{iq}, I_{qi}, I_{qq} and Q outputs Qᵢᵢ, Q_{iq}, Q_{qi}, Q_{qq} processed by the chirp code wipeoff and I&D module 351 in the early and late channels are calculated via the adders before input to the code chip error discriminator 3622. For example, the two combined real correlations are obtained by subtracting I_{qq} from Iᵢᵢ and adding I_{iq} to I_{qi}, and another two combined real correlations are calculated by subtracting Q_{qq} from Qᵢᵢ and adding Q_{iq} to Q_{qi}; there are toally four combined real correlations computed from the original input Iᵢᵢ, I_{iq}, I_{qi}, I_{qq} and Qᵢᵢ, Q_{iq}, Q_{qi}, Q_{qq} to the carrier loop discriminator 363 in the early channel; there is also another pair of four combined real correlations produced by the late channels; these eight combined real correlations are input to the code chip error discriminator 3622 to estimate the code chip error. The output of the code chip error discriminator 3622 is input to the code loop filter and its output is used to update the code NCO 34. The number of adders may vary, and the number of the combined real correlations may also vary in the code loop discriminator 362.

In one embodiment, the apparatus 3 is selected from the group consisting of a GNSS receiver, a low-Earth orbit (LEO) satellite signal receiver, and a long-term evolution (LTE) signal receiver, a fifth generation (5G) signal receiver, and a navigation signal receiver. In certain configurations, the apparatus 3 may be implemented as a multi-mode receiver capable of seamlessly switching between different signal standards, thereby supporting interoperability across heterogeneous communication and navigation systems.

In one embodiment, the apparatus 3 includes a navigator (not shown) configured to receive pseudorange and carrier phase measurements from the receiver processor 36 and compute positioning, navigation, or timing solutions. The navigator may further integrate correction data such as differential GNSS or satellite-based augmentation system (SBAS) messages, enabling enhanced accuracy and integrity monitoring in safety-critical applications.

In one embodiment, the apparatus 3 is configured to operate in a vector-tracking architecture using vector delay lock loop (VDLL) and vector phase lock loop (VPLL) implementations with the chirp-signal-modulated samples. Such a vector-tracking framework allows joint processing of multiple channels, improving resilience against signal blockage and interference, and enabling tighter coupling with external aiding sources such as inertial sensors.

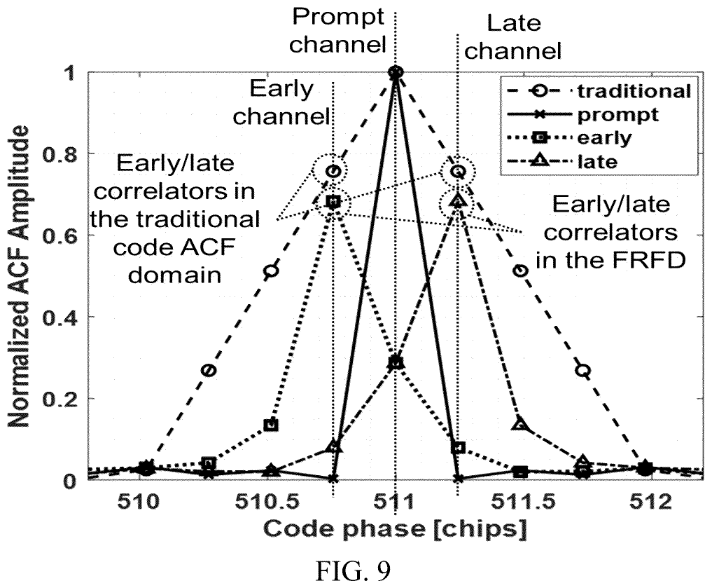

Please refer to FIG. 9, which shows a comparison of correlation amplitude results from the embodiment of FIG. 5 with conventional correlation amplitude results. In FIG. 9, the GPS L1 C/A code with the PRN number of 1 is simulated for the present embodiment as the GNSS receiver for tracking the DSSS signals. The code rate of GPS L1 C/A signals is 1.023 MHz. In the simulation, we use an IF sampling rate of 4.2 MHz. The correlation amplitude results from early, prompt, and late channels are plotted for both the traditional receiver and the present embodiment in FIG. 9. Notably, the conventional results are located at the dashed line with the circle markers; the results from the present embodiment are illustrated with the different lines with the markers of squares, triangles, and crosses, respectively. In other words, the present embodiment can track the DSSS signals in the various dimensions using the new correlation results formed in the FRFD.

In summary, the present disclosure provides a method and an apparatus for tracking a direct sequence spread spectrum (DSSS) signal in a fractional Fourier domain (FRFD), addressing the limitations of current Global Navigation Satellite System (GNSS) receivers, which struggle with multipath and interference in challenging environments due to their reliance on conventional signal processing methods. This approach introduces a novel baseband processor that utilizes fractional Fourier transform (FRFT) theory to extend signal processing from a one-dimensional (1D) code-phase/time domain to a two-dimensional (2D) FRFD. This is achieved by modulating both the incoming signal and local code replicas with chirp signals. The advantages of this architecture include accelerating the code rates of received spreading codes and enhancing the autocorrelation function (ACF), which significantly improves tracking accuracy and provides more robust and precise positioning, navigation, and timing solutions. The method is economical and practical as it only requires modifying the receiver side without altering the signals transmitted from satellites. Benchmark test results have demonstrated that this method can accurately compute satellite velocity and acceleration.

It should be noted that the embodiments described above can be freely combined as needed. They are merely preferred embodiments of the present disclosure. It should be pointed out that for those skilled in the art, several improvements and modifications can be made without departing from the concept of the present disclosure. Such improvements and modifications should also be included within the scope of the present disclosure.

1. A method for tracking a direct sequence spread spectrum (DSSS) signal in a fractional Fourier domain (FRFD), the method comprising the steps of:
receiving an intermediate frequency (IF) DSSS signal;
removing a Doppler frequency component from the received IF DSSS signal by mixing with local sine and cosine waveforms generated by a carrier numerically controlled oscillator (NCO) to obtain a plurality of in-phase (I) and quadra-phase (Q) carrier-stripped signal samples;
performing code tracking and integration-and-dumping (I-and-D) implementations in the FRFD;
discriminating carrier phase errors using I and Q prompt correlations and discriminating code chip errors using I and Q early and late correlations via carrier and code discriminators;
processing the discriminated carrier phase errors and the discriminated code chip errors through a low-pass carrier and code loop filter; and
using outputs of the low-pass carrier and code loop filter to generate carrier and code measurements and to adjust the carrier NCO and a code NCO in real time for tracking the received IF signals in a next epoch.

2. The method of claim 1, wherein the step of performing the code tracking and the I-and-D implementations further comprises:
modulating the I and Q carrier-stripped signal samples with sine and cosine local chirp signal replicas generated by a chirp-signal NCO;
modulating a plurality of local spreading code replica samples generated by the code NCO with the sine and cosine local chirp signal replicas, wherein early (E), prompt (P), and late (L) channels are adjusted by local chirp signal phases;
correlating the sine-and cosine-chirp-modulated I and Q samples with the E, P, and L chirp-signal-modulated sine and cosine local code replicas via an I and Q processor; and
applying complex multiplication operations to the correlations for each of the E, P, and L channels.

3. The method of claim 2, further comprising modulating either one of sine and cosine local chirp waveforms to the received IF DSSS signal and local signal replicas simultaneously.

4. The method of claim 2, further comprising:
modulating the local chirp signal replicas to local carrier replicas and the received IF DSSS signal where code signals are wiped off; and
implementing code wipeoff functions either before or after carrier wipeoff function implementation.

5. The method of claim 2, further comprising replacing the local chirp signal replicas with the local sine and cosine waveforms having unchanged frequencies, wherein the local sine and cosine waveforms are modulated on the received IF DSSS signal and local signal replicas simultaneously.

6. The method of claim 2, wherein the local chirp signal replicas are designed according to an optimal chirp rate computed via a closed-form analytical model to guarantee a predefined correlation power threshold in a Doppler rate dimension, thereby minimizing search complexity.

7. The method of claim 1, further comprising:
conducting a plurality of pseudorange and carrier phase measurements based on the outputs of the loop filter; and
inputting the measurements to a navigator to compute positioning, navigation, or timing solutions.

8. The method of claim 1, further comprising using the outputs of the carrier and code loop filter to compensate for code phase errors and Doppler frequency errors in an acquisition process, wherein the received I and Q carrier-stripped signal samples and local signal replicas are selectively modulated by sine and cosine local chirp signal replicas during acquisition processing.

9. The method of claim 1, further comprising:
disabling the low-pass carrier and code loop filter, so that outputs of a code and carrier discriminator are used for producing pseudorange and carrier phase measurements in open-loop and snapshot receiver architectures, and the outputs of the code and carrier discriminator are used for compensating Doppler frequency errors and the code chip errors of the code NCO and the carrier NCO.

10. The method of claim 1, further comprising forming additional correlators and implementing a code phase discriminator based on multi-channel correlations using a multipath estimation delay lock loop (MDELL) algorithm and variations thereof by designing early and late channels in a receiver architecture.

11. The method of claim 1, wherein the received IF DSSS signal and local signal replicas modulated by local chirp signal replicas are adopted in receivers using vector delay lock loop (VDLL) and vector phase lock loop (VPLL) architectures.

12. The method of claim 1, wherein the received IF DSSS signal and local signal replicas modulated by local chirp signal replicas are adopted in a deeply coupled GNSS/inertial navigation system (INS).

13. The method of claim 1, wherein the received IF DSSS signal is a global navigation satellite system (GNSS) signal and the method further comprises:
producing a plurality of pseudorange and carrier phase measurements based on estimated code phases, carrier phases and Doppler frequencies; and
computing position solutions with the produced pseudorange and carrier phase measurements in a navigator.

14. The method of claim 13, wherein the step of computing the position solutions is executed by at least one of: a standalone GNSS receiver, an integrated GNSS/inertial sensor navigation system, and a non-GNSS signals-of-opportunity (SoOP) navigation receiver.

15. An apparatus for tracking a direct sequence spread spectrum (DSSS) signal in a fractional Fourier domain (FRFD), the apparatus comprising:
a mixer configured to remove a Doppler frequency component from a received intermediate frequency (IF) DSSS signal by mixing with local sine and cosine waveforms to obtain a plurality of in-phase (I) and quadra-phase (Q) carrier-stripped signal samples;
a carrier numerically controlled oscillator (NCO) configured to generate the local sine and cosine waveforms through a cos/sin map block;
a code NCO configured to generate local spreading code replica samples;
a processing module configured to perform code tracking and integration-and-dumping (I-and-D) implementations in the FRFD; and
a receiver processor configured to:
discriminate carrier phase errors using I and Q prompt correlations;
discriminate code chip errors using I and Q early and late correlations;
process the discriminated errors through low-pass loop filters; and
generate carrier and code measurements for adjusting the carrier NCO and the code NCO.

16. The apparatus of claim 15, further comprising a chirp-signal NCO configured to modulate the I and Q carrier-stripped signal samples with sine and cosine local chirp signal replicas.

17. The apparatus of claim 15, wherein the chirp-signal NCO is configured to generate chirp rates determined from a closed-form analytical model that guarantees a predefined correlation power threshold in the Doppler rate dimension, thereby reducing search complexity.

18. The apparatus of claim 15, wherein the processing module comprises:
a plurality of chirp code wipeoff and I-and-D units, each configured to output correlation samples based on sine-and cosine-chirp-signal-modulated received I and Q samples and sine-and cosine-chirp-signal-modulated local code samples.

19. The apparatus of claim 18, wherein each chirp code wipeoff and I-and-D unit comprises:
a cosine chirp carrier generator configured to generate cosine chirp signal waveforms;
a sine chirp carrier generator configured to generate sine chirp signal waveforms;
a spreading code generator configured to generate local pseudorandom noise (PRN) code replicas;
a local code and cosine chirp carrier modulator configured to modulate local code replicas with cosine chirp signals;
a local code and sine chirp carrier modulator configured to modulate local code replicas with sine chirp signals;
a received code and cosine chirp carrier modulator configured to modulate received carrier-stripped samples with cosine chirp signals;
a received code and sine chirp carrier modulator configured to modulate received carrier-stripped samples with sine chirp signals;
a plurality of code wipeoff function operators configured to multiply outputs of the modulators; and
a plurality of I-and-D function operators configured to process outputs of the code wipeoff functions.

20. The apparatus of claim 15, wherein the receiver processor comprises:
a carrier loop discriminator configured to receive I and Q correlations from prompt channels and discriminate carrier phase errors;
a code loop discriminator configured to receive I and Q correlations from early and late channels and discriminate code chip errors;
a carrier loop filter configured to process discriminated carrier phase errors; and
a code loop filter configured to process discriminated code chip errors.

21. The apparatus of claim 20, wherein the carrier loop discriminator comprises:
a plurality of adders configured to combine correlation samples; and
a phase lock loop (PLL) discriminator configured to estimate carrier phase errors from combined correlation samples.

22. The apparatus of claim 20, wherein the code loop discriminator comprises:
a plurality of adders configured to combine correlation samples from early and late channels; and
a code chip error discriminator configured to estimate code chip errors from combined correlation samples.

23. The apparatus of claim 15, wherein the apparatus is selected from the group consisting of a GNSS receiver, a low-Earth orbit (LEO) satellite signal receiver, and a long-term evolution (LTE) signal receiver, a fifth generation (5G) signal receiver, and a navigation signal receiver.

24. The apparatus of claim 15, further comprising a navigator configured to receive pseudorange and carrier phase measurements from the receiver processor and compute positioning, navigation, or timing solutions.

25. The apparatus of claim 15, wherein the low-pass loop filters comprise at least one filter selected from the group consisting of delay lock loop (DLL), phase lock loop (PLL), frequency lock loop (FLL), Kalman filter (KF), maximum likelihood estimator (MLE), and maximum a posteriori estimator (MAP).

26. The apparatus of claim 15, wherein the apparatus is configured to operate in a vector-tracking architecture using vector delay lock loop (VDLL) and vector phase lock loop (VPLL) implementations with the chirp-signal-modulated samples.
